(19) United States
(12) Patent Application Publication
(10) Pub. No.: US 2023/0257294 A1
(43) Pub. Date: Aug. 17, 2023

(54) ALUMINOSILICATE GLASS

(71) Applicant: Macquarie University, North Ryde (AU)

(72) Inventors: Toney Teddy Fernandez, North Ryde (AU); Simon Gross, North Ryde (AU); Michael Withford, North Ryde (AU)

(21) Appl. No.: 17/787,007

(22) PCT Filed: Dec. 18, 2020
(86) PCT No.: PCT/AU2020/051390

§ 371 Date: Jun. 24, 2022

(30) Foreign Application Priority Data
Dec. 18, 2019 (AU) 2019904794

(51) Int. Cl. C03C 3/091; C03C 3/087; G02B 6/13; C03C 23/00

(52) U.S. Cl. CPC C03C 3/091; C03C 3/087; G02B 6/13; C03C 23/0025; G02B 2006/12171

(57) ABSTRACT

An aluminosilicate glass having a composition according to the following formula (I):

(100−(1+a₁+b₁)·x)SiO₂·(x)Al₂O₃·(a₁·x)MO·(b₁·x)R (wt %) (I)

in which MO is alkaline earth metal oxide, the alkaline earth metal M being one or more of Mg, Ca, Sr, and Ba, R comprises alkali metal oxide, the alkali metal being one or more of Li, Na, and K, x is at least 15, a₁ is at least 0.35, b₁ is at least 0.55, and wherein the product of a₁ and b₁ is at least 0.22.

### FIELD OF THE INVENTION

The invention relates generally to a silicate glass composition, and in particular to an aluminosilicate silicate glass composition.

### BACKGROUND OF THE INVENTION

Aluminosilicate glass is nowadays mostly employed as an optical material for display glasses and protective cover glass.

To some extent, conventional aluminosilicate glass is also used as an optical component as part of more sophisticated optical data transmission circuits. For example, conventional aluminosilicate glass may be used as a platform for the direct laser inscription of optical waveguides. However, conventional aluminosilicate glass presents a number of limitations in terms of optical transmission and refractive index that limit its applicability as optical material.

There remains therefore an opportunity to develop aluminosilicate glass that can address or ameliorate the limitations of conventional aluminosilicate glass.

### SUMMARY OF THE INVENTION

The present invention provides aluminosilicate glass having a composition according to the following formula:

(100−(1+a₁+b₁)·x)SIO₂·(x)Al₂O₃·(a₁·x)MO·(b₁·x)R (wt %)

in which:
MO is alkaline earth metal oxide, the alkaline earth metal M being one or more of Mg, Ca, Sr, and Ba,
R comprises alkali metal oxide, the alkali metal being one or more of Li, Na, and K,
x is at least 15,
a₁ is at least 0.35, and
b₁ is at least 0.55,

wherein the product of a₁ and b₁ is at least 0.22.

Unless stated otherwise, all composition values used herein are expressed in wt. % relative to the total weight of the aluminosilicate glass.

Relative to conventional aluminosilicate glass, the glass of the invention comprises unique combinations of (i) an oxide of an alkaline earth metal selected from one or more of Mg, Ca, Sr, and Ba, and (ii) an oxide of alkali metal selected from one or more of Li, Na, and K.

As shown in FIG. 1, such unique combinations of elements (i.e. alkaline earth oxides plus alkali oxides) is not present in conventional commercial glasses. While the alkaline earth metal(s) can contribute to a number of desired optical properties of the glass (e.g. adequate refractive index), in conventional glasses they can also weaken the glass structure. However, in the glass of the invention the co-presence of alkali metal oxide(s) in the proposed amount advantageously stabilises the glass structure. This enables to manufacture a glass having higher content of alkaline earth metal(s), and therefore improved optical characteristics, relative to conventional glass. This is particularly useful in the manufacture of optical components, which can be produced with the desired optical characteristics at much higher throughput relative to conventional glasses.

In some embodiments, the aluminosilicate glass has a formula where R further comprises B₂O₃. The inclusion of B₂O₃ has surprisingly been found to be particularly advantageous for the production of optical components. For example, it is believed the presence of B₂O₃ can facilitate densification of the glass structure and control inter-diffusivity of metal species during manufacture. This is particularly advantageous, for example, during direct laser inscription of optical waveguides, in which presence of B₂O₃ can facilitate waveguide inscription at faster writing speeds relative to conventional glass.

In some embodiments, b₁ is at least 0.65. In those instances, the invention may be said to relate to aluminosilicate glass having a composition according to the following formula:

(100−(1+a₁+b₁)·x)SIO₂·(x)Al₂O₃·(a₁·x)MO·(b₁·x)R (wt %)

in which:
MO is alkaline earth metal oxide, the alkaline earth metal M being one or more of Mg, Ca, Sr, and Ba,
R comprises alkali metal oxide, the alkali metal being one or more of Li, Na, and K,
x is at least 15,
a₁ is at least 0.35, and
b₁ is at least 0.65,

wherein the product of a₁ and b₁ is at least 0.22.

In some embodiments, the glass comprises alkaline earth and Al₂O₃ in a ratio (a₁) from 0.35 to 0.65. In some embodiments, the glass comprises alkaline earth and Al₂O₃ in a ratio (a₁) from 0.45 to 0.75. In some embodiments, the glass comprises alkali metal and Al₂O₃ according to a ratio (b₁) from 0.55 to 0.8. In some embodiments, the glass comprises alkali metal and Al₂O₃ according to a ratio (b₁) from 0.65 to 0.9. In those instances, the glass can be particularly useful for high throughput laser inscription of optical waveguides. Focusing a laser beam within the glass induces highly localised heating of the glass in correspondence to the focal point of the beam.

Without wishing to be limited by theory, it is believed the ensuing thermal gradient is sufficient to promote significant redistribution of elements in correspondence to the focal point of the beam. Inter-diffusion of metal species to and from the focal point of the beam may therefore result in formation of a spatially confined volume of glass having a different composition, and therefore optical properties, than the surrounding glass. Moving the focal point of the beam through the volume of glass allows inscribing shaped paths within the glass that have altered composition relative to the surrounding glass. Those paths can advantageously function as optical waveguides for the preferential transmission of light. By the expression “optical waveguide” is therefore meant a discontinuity of the glass composition that defines a path through which light can be transmitted preferentially relative to the surrounding glass. A schematic example of optical waveguides defined within a glass is shown in FIG. 2.

Accordingly, in some embodiments the aluminosilicate glass of the invention has an optical waveguide inscribed therein.

Optical waveguides inscribed within the glass of the invention can display excellent guiding capability with minimal optical loss. In addition, the composition of those embodiment glasses is especially balanced to ensure fast inter-diffusion of composition elements during direct laser inscription over a wide range of inscription rates, which is particularly advantageous for high throughput manufacture of optical components.

Compositions of the aluminosilicate glass in which MO comprises CaO are particularly advantageous for the direct laser inscription of optical waveguides, providing waveguides characterised by higher refractive index contrast relative to waveguides inscribed within conventional glass. Accordingly, in some embodiments MO comprises CaO. As used herein, the expression “refractive index contrast” means the difference between the refractive index of the waveguide core and that of the surrounding glass. Optimal refractive index contrast ensures strong light confinement and minimal transmission losses, in turn making it possible to produce curved waveguides with tighter bends relative to conventional waveguides.

The present invention also provides a method of forming an optical waveguide, the method comprising the steps of (a) focusing a laser beam within an aluminosilicate glass of the kind described herein, and (b) moving a focal point of the laser beam through the glass, thereby forming the optical waveguide.

The unique composition of the aluminosilicate glass advantageously enables fast inscription of optical waveguides. For example, it may be possible to inscribe an optical waveguide by moving the focal point of the laser beam through the glass at a speed of up to 4,000 mm/min. Said speed will be referred herein also by the expression “feed rate”. Thanks to the specific composition of the glass, the resulting waveguide can present a refractive index contrast higher than 0.001. In some instances, the inscribed optical waveguide may have a refractive index contrast as high as 0.02.

Accordingly, there is also provided a glass having an optical waveguide inscribed therein by the method described herein.

The glass of the present invention represents an advantageous optical platform for the production of optical components that require optimal combinations of high refractive index contrast and low optical loss. In particular, the glass of the invention is particularly advantageous for direct inscription of optical waveguides with high refractive index contrast and minimal loss at fast feed rates.

Further aspects and/or embodiments of the invention are discussed in more detail below.

### BRIEF DESCRIPTION OF THE DRAWINGS

Embodiments of the invention will be now described with reference to the following non-limiting drawings, in which:

FIG. 1 shows a comparison between the alkali and alkaline earth content between embodiment aluminosilicate glasses in accordance to the invention and commercial aluminosilicate glasses,

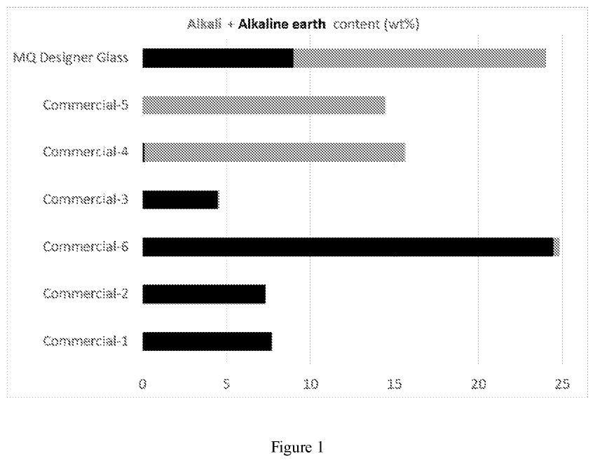

FIG. 2 shows a schematic of an optical circuit (custom made multiplexer) made of optical waveguides inscribed within glass,

FIG. 3 shows cross-sectional morphology of waveguides direct laser-written on embodiment glass in accordance to the invention,

FIG. 4 shows elemental migration towards the positive refractive index zone of waveguides obtained using embodiment glasses obtained in Example 1 at feed rates from 10 mm/min to 2,000 mm/min,

FIG. 5 shows the refractive index change obtained for 30 μm structure waveguides direct laser-written on embodiment glasses having different alkali metal oxide (Na₂O) to Al₂O₃ (b₁) ratios,

FIG. 6 shows refractive index change obtained for waveguides direct laser-written on embodiment glasses 8-10 listed in Table 1,

FIG. 7 shows cross-sectional morphology of waveguides direct laser-written on embodiment glasses 8-10 listed in Table 1,

FIG. 8 shows refractive index change obtained for waveguides direct laser-written on embodiment glasses compared to that of waveguides obtained on commercial glass,

FIG. 9 shows the laser-writing feed rates afforded by embodiment glasses of the invention relative to that of a number of commercial glasses, and

FIG. 10 shows the loss versus maximum feed rates combination obtained for embodiment glasses of the invention relative to a number of commercial glasses.

### DETAILED DESCRIPTION OF THE INVENTION

The present invention relates to aluminosilicate glass having a composition according to the following formula (I):

(100−(1+a₁+b₁)·x)SIO₂·(x)Al₂O₃·(a₁·x)MO·(b₁·x)R (wt %) (I)

In formula (I), MO represents alkaline earth metal oxide, in which M is one or more of Mg, Ca, Sr, and Ba. That is, the formula is intended to encompass glass compositions containing any one oxide of Mg, Ca, Sr, and Ba, or any combination of two or more oxides of Mg, Ca, Sr, and Ba. For example, the glass may contain MgO, CaO, SrO, BaO, or a combination of two or more thereof.

In some embodiments, MO is MgO. In some embodiments, MO is CaO. In some embodiments, MO is SrO. In some embodiments, MO is BaO. In some embodiments, MO is MgO and CaO. In some embodiments, MO is MgO and SrO. In some embodiments, MO is MgO and BaO. In some embodiments, MO is MgO, CaO, and SrO. In some embodiments, MO is MgO, CaO, and BaO. In some embodiments, MO is MgO, SrO, and BaO. In some embodiments, MO is MgO, CaO, SrO, and BaO. In some embodiments, MO is CaO and SrO. In some embodiments, MO is CaO and BaO. In some embodiments, MO is CaO, SrO, and BaO. In some embodiments, MO is SrO and BaO.

In some embodiments, MO comprises two or more of MgO, CaO, SrO and BaO. For example, MO may be MgO and CaO, CaO and SrO, or MgO and BaO. Those embodiments are particularly advantageous for the direct laser writing of optical waveguides, in that as the metal elements get heavier in atomic weight, larger refractive index change can be achieved through elemental migration. This affords production of waveguides with higher refractive index with structural consistency over a large bandwidth of laser writing parameters.

In formula (I), R comprises alkali metal oxide, in which the alkali metal is one or more of Li, Na, and K. That is, the formula is intended to encompass glass compositions containing any one oxide of Li, Na, and K, or any combination of two or more oxides of Li, Na, and K. For example, the glass may contain Li₂O, Na₂O, K₂O, or a combination of two or more of Li₂O, Na₂O, K₂O. In some embodiments, R is Li₂O. In some embodiments, R is Na₂O. In some embodiments, R is K₂O. In some embodiments, R is Li₂O and Na₂O. In some embodiments, R is Li₂O and K₂O. In some embodiments, R is Li₂O, Na₂O, and K₂O. In some embodiments, R is Na₂O and K₂O. In some embodiments, the glass comprises any one oxide of Li, Na, and K.

The nature and relative amount of elements of formula (I) provide a particularly balanced and advantageous combination of glass formers and glass modifiers. The resulting glass represents an attractive platform for the high throughput manufacture of optical components.

In some embodiments, MO is at least CaO. These embodiments are particularly advantageous in the context of glass processing to produce optical components, for example, when the glass is used for direct laser writing of optical waveguides. In that regard, Ca has been observed to contribute to increase the refractive index of the glass, as well as to enhance the refractive index contrast of optical waveguides inscribed within the glass by direct laser writing. Without wanting to be limited by theory, it is understood that Ca is sufficiently mobile within the glass structure such that it can preferentially diffuse from the bulk of the glass into the heated volume of glass corresponding to the focal point of the laser beam during laser inscription.

In formula (I), the value of x (which represents the amount of Al₂O₃ in wt %) is at least 15. In general, being an intermediate, aluminium can be expected to perform the role of network modifier and/or glass former. At the proposed amount, it was observed that aluminium prefers to assume the role of a glass former, especially when the glass is used for the direct-laser inscription of optical waveguides. In addition, for application such as direct laser writing of optical waveguides it was found that by increasing the amount of Al₂O₃ it is possible to improve consistency in the shape structure of laser inscribed waveguides, thus enabling efficient integration of devices.

In some embodiments, x is from 15 to 25. In some embodiments, x is 18. These embodiments provide for glasses that are particularly suitable for the direct laser writing of optical waveguides. The waveguides are formed mainly due to structural and elemental reorganization of the glass composition in the volume surrounding the focal point of the laser beam during laser inscription. In that context, aluminium was found to contribute to the densification of the waveguide core, with silicon being the exchanging element to form a rarefied zone surrounding the core. Accordingly, at the proposed amount aluminium is particularly effective to promote fast consolidation of the glass network within the waveguide core during laser writing. In conjunction with aluminium's strong affinity towards the alkaline earth metal(s), aluminium in the proposed amount is a particularly effective contributor to fast feedrate formation of optical waveguides with high refractive index contrast.

In formula (I), the value of a₁ (which represents the relative amount between alkaline earth metal oxide and Al₂O₃) is at least 0.35. The alkaline earth metal(s) in MO acts as network modifier to alter the glass network, in turn reducing its connectivity and viscosity. At the proposed value of a₁, the glass is characterised by a particularly advantageous balance between glass viscosity and metal ion mobility. In turn, this assists with glass manufacture and the applicability of the proposed glass in optical devices. In addition, the proposed value of a₁ is beneficial to reduce the extent of phase separation that may occur during manufacture and processing.

In some embodiments, a₁ is from 0.35 to 0.65. In some embodiments, a₁ is from 0.45 to 0.75. These embodiments provide for glasses that are particularly suitable for the direct laser writing of optical waveguides. By tuning the ratio between alkaline earth metal oxide and Al₂O₃ it is possible to modulate the extent of phase separation occurring within the waveguides as they quench immediately after laser inscription. In that regard, it was observed that by tuning the value of a₁ within those ranges it is possible to decide whether the waveguide after inscription will be predominantly amorphous or phase separated. While glasses with higher aluminium content (i.e. lower a₁) tend to provide waveguides with a better aspect ratio of the guiding region over a large laser feed-rate window, glasses with a higher content of alkaline earth metal (e.g. Ca) result in waveguides with higher refractive index contrast since the primary source of refractive index increase is observed to stem from the migration of alkaline earth metal (e.g. Ca) towards the light guiding region of the waveguide structure. In that context, a value of a₁ equal to 0.5 was observed to be particularly advantageous. Accordingly, in some embodiments a₁ is 0.5.

In formula (I), b₁ (which represents the relative amount between alkali metal oxide and Al₂O₃) is at least 0.55. In some embodiments, b₁ is at least 0.65. Presence of alkali metals facilitates formation of the glass due to their role as modifiers. At the same time, the amount of alkali metals imposed by formula (I) ensures that the glass can be manufactured with higher content of alkaline earth metals relative to commercial glasses. In turn, waveguides with higher refractive index contrast surpassing the crystallization or phase separation within them can be obtained.

In some embodiments, b₁ is less than 1. For example, b₁ may be from 0.65 to 0.9. In some embodiments, b₁ is from 0.55 to 0.8. When b₁ is less than 1, the aluminosilicate glass is particularly suitable for the direct laser writing of optical waveguides. In those instances, the glass is suitable to produce waveguides with good optical guiding characteristics over a large laser feed-rate window. When b₁ exceeds 1, the resulting waveguides have been observed to progressively drop their guiding ability. Waveguides of good optical quality and guiding characteristics can be obtained, for example, by having b₁ equal to 0.835.

In formula (I), the product of a₁ and b₁ is at least 0.22. This ensures an appropriate balance between Al₂O₃, alkaline earth metal(s), and alkali metal(s) in the glass. The resulting glass is easy to manufacture and can be particularly useful for the manufacture of optical components, which can be produced with the desired optical characteristics at much higher throughput relative to conventional glasses. In addition, when the glass is used for the direct laser writing of optical waveguides, the product of a₁ and b₁ being at least 0.22 ensures good guiding characteristics of the waveguide core and consistent waveguide structure.

In some embodiments, x is from 15 to 25, a₁ is from 0.35 to 0.65, and b₁ is from 0.65 to 0.9.

In some embodiments, x is from 15 to 25, a₁ is from 0.45 to 0.75, and b₁ is from 0.55 to 0.8.

In some embodiments, x is 18, a₁ is 0.5, and b₁ is 0.835.

In some embodiments, R in formula (I) further comprises B₂O₃.

The inclusion of B₂O₃ has surprisingly been found to be particularly advantageous for the production of optical components. Without wanting to be confined by theory, addition of B₂O₃ is believed to increase the fraction of non-bridging oxygen containing borate and silicate structural units. The higher amount of non-bridging oxygen contributes to a decrease of the network connectivity, thus reducing the softening temperature and melting point of the glass. This can be particularly advantageous, for example, during direct laser inscription of optical waveguides, in which presence of B₂O₃ can facilitate waveguide inscription at faster feed rates. In that regard, during laser inscription B₂O₃ can effectively modulate the inter-diffusion of elements responsible (a) for glass consolidation and/or (b) to confer the glass with specific optical characteristics. This assists with ensuring that the resulting waveguide is characterised by a desired refractive index contrast.

In some embodiments, the aluminosilicate glass contains B₂O₃ in an amount of up to 10 wt. %. For example, the aluminosilicate glass may contain about 0.1 wt. %, about 0.5 wt. %, about 1 wt. %, about 2.5 wt. %, about 5 wt. %, about 7.5 wt. %, or about 10 wt. % of B₂O₃. In some embodiments, the aluminosilicate glass contains B₂O₃ in an amount of between 0.01 wt. % to about 10 wt. %.

In some embodiments, the aluminosilicate glass has a formula (52-62)SiO₂·(15-20)Al₂O₃·(7-14)CaO·(7-14)Na₂O·(5-10)B₂O₃ (wt. %).

In some embodiments, the aluminosilicate glass has a formula 58SiO₂·18Al₂O₃·9CaO·15Na₂O (wt. %, a₁=0.5, b₁=0.833).

In some embodiments, the aluminosilicate glass has a formula 58SiO₂·18Al₂O₃·9CaO·10Na₂O·5B₂O₃ (wt. %, a₁=0.5, b₁=0.833).

In some embodiments, the aluminosilicate glass has a formula 57.2SiO₂·15.3Al₂O₃·10CaO·10NaO·7.5B₂O₃ (wt. %, a₁=0.65, b₁=0.65).

In some embodiments, the aluminosilicate glass has a formula 55SiO₂·>18Al₂O₃·10CaO·13NaO·1MgO·3B₂O₃ (wt. %, a₁=0.61, b₁=0.72).

In some embodiments, the aluminosilicate glass has a formula 60SiO₂·18Al₂O₃·9CaO·11.7NaO·1.3MgO (wt. %, a₁=0.57, b₁=0.65).

In some embodiments, the aluminosilicate glass has a formula 56SiO₂·20Al₂O₃·10CaO·13NaO·1MgO (wt. %, a₁=0.55, b₁=0.65).

Provided the aluminosilicate glass has a composition according to formula (I) as described herein, the glass may be produced by any means known to the skilled person. Suitable procedures in that regard include those known in the art as melt-quenching, thermal evaporation, sputtering, RF Glows charge, chemical vapour deposition, sol-gel, and electrolytic deposition.

Typically, the glass of the invention has a refractive index above 1.45. In some embodiments, the aluminosilicate glass has a refractive in a range of from 1.45 to 1.55.

As a skilled person will appreciate, the aluminosilicate glass of the invention may also contain unavoidable impurities. As used herein, the expression “unavoidable impurity” refers to an element other than those of the aluminosilicate glass that is inevitably present in the glass as a result of the specific synthesis of the glass, for example because inherently present in the glass precursors. An example of such impurities is iron, and in particular iron ions such as Fe²⁺. Excessive amount of iron can be detrimental to the optical quality of the glass, since their presence can induce a broad optical absorption band, and associated optical losses, between 600-3,000 nm. A skilled person would nevertheless be aware of strategies to minimise presence of iron ions in the glass, for example by selecting high purity glass precursors, refraining from the use of iron oxide as fining agent, etc. Typically, the amount of Fe²⁺ content in the aluminosilicate glass is controlled and limited to a value that leads to the glass optical absorption of less than 0.2 dB/cm between 600 to 3,000 nm. As a skilled person would know, presence of Fe²⁺ ions in glass can produce a broad absorption band absorption centred at about 1,100 nm. A skilled person would therefore be aware of how to measure that absorption and determine the corresponding absorption value.

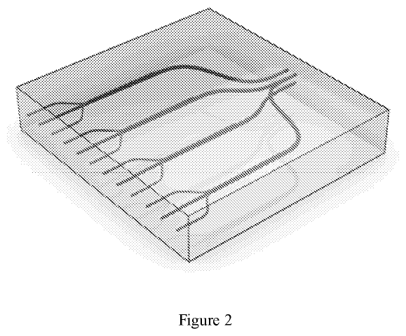

The aluminosilicate glass of the invention is particularly useful as a substrate for the direct laser writing of optical waveguides. Accordingly, in some embodiments the aluminosilicate glass has an optical waveguide inscribed therein. A schematic example of a glass having an optical waveguide inscribed therein is shown in FIG. 2. The schematic is one of a custom made multiplexer having a number of waveguides of customised shape inscribed therein.

The optical waveguide may provide for a refractive index contrast that enables the waveguide to spatially confine and transmit photons. In some embodiments, the aluminosilicate glass has a Type I optical waveguide inscribed therein. In that regard, the waveguide may provide a refractive contrast higher than 0.001. In some embodiments, the optical waveguide provides for a refractive contrast of up to 0.02.

The present invention also relates to a method of forming an optical waveguide, comprising a step of focusing a laser beam within an aluminosilicate glass of the kind described herein.

Any means known to the skilled person may be used to focus a laser beam within the aluminosilicate glass. For example, this may be achieved by using one or more optical lenses and or mirrors that interact with the beam transmitted by a laser source such that the beam is made to converge into a focal point that is located within the volume of the glass. By “focal point” is meant the portion of the laser beam having the smallest cross-sectional dimension. For the purpose of the method of the invention, the laser beam may therefore be any laser beam that can be focused into a full point within the glass to provide local heating of the glass in correspondence with said focal point.

Without wanting to be limited by theory, local heating of the glass in correspondence to the focal point generates a localised thermal gradient between the portion of the glass within and immediately surrounding the focal point of the laser beam and the non-irradiated glass. Said localised thermal gradient is believed to promote inter-diffusion of the structural elements of the glass to and from the focal point. In that regard, it is believed that the stimulus for migration of elements is mainly thermal (i.e. thermo-migration), and that the structural elements of the glass inter-diffuse according to directions that generally depend on the shape of the beam. In some embodiments, the laser spot will comprise multiple foci.

The focal point of the laser beam may have any dimension conducive to direct laser writing of the aluminosilicate glass. As a skilled person would know, the dimension of the focal point of the laser beam may be tuned to be tight or loose depending on the intended geometric characteristics of the final waveguide structure. In some embodiments, the focal point of the laser beam has an average dimension of from about 0.1 μm to about 30 μm, from about 0.1 μm to 10 μm, or from about 0.1 μm to 5 μm.

In some embodiments, the laser beam is an ultrashort laser beam. For example, the laser beam may be an ultrashort laser beam with a duration shorter than 10 picoseconds. Writing optical waveguides in transparent materials with ultrashort laser pulses provides extreme flexibility in terms of the choice of substrate materials, the geometry of the mode field profile, and the configuration of three-dimensional (3D) optical circuits.

In some embodiments, the laser beam is a femtosecond laser beam. The ultrashort laser beam may be characterised by any duration and may be operated at any repetition rate conducive to formation of an optical waveguide. For example, the laser beam may be an ultrashort laser beam with a duration shorter than 10 picoseconds and operating at a repetition rate in the range of from 10 kHz to 100 MHz.

The laser beam may operate at any wavelength conducive to local heating of the glass in correspondence with the focal point. Examples of suitable wavelengths for use in the invention include wavelengths in the range of from about 400 nm to about 2,200 nm. In some embodiments, the laser beam operates at a wavelength in the range of from about 400 nm to about 1,500 nm, from about 400 nm to about 1,000 nm, from about 600 nm to about 1,000 nm, or from about 800 nm to about 1,000 mm. In some embodiments, the laser beam operates at a wavelength of about 800 nm.

In some embodiments, the laser beam is an ultrashort laser beam with a duration shorter than 10 picosecond and operating at a wavelength in the range of from about 400 to about 2,200 nm.

In some embodiments, the laser beam is a pulsed femtosecond laser operating at 50 fs pulses and a wavelength of 800 nm.

The laser beam may provide any value of energy that is conducive to local heating of the glass in correspondence with the focal point. In some embodiments, the laser beam provides an energy of from about 10 nJ to about 1 μJ, from about 25 nJ to about 150 nJ, from about 50 nJ to about 100 nJ, or from about 25 nJ to 300 nJ. In some embodiments, the input beam is a laser beam provides an energy of at least about 10 nJ, about 20 nJ, about 40 nJ and about 55 nJ. In some embodiments, the laser beam has an energy in the range of about 10 nJ to about 1000 nJ.

The method of the invention also comprises a step of moving a focal point of the laser beam through the glass, thereby forming the optical waveguide.

The focal point of the laser beam is moved through the glass to define a predetermined path, along which the composition of the glass is permanently altered relative to that of the native glass. In that regard, moving the focal point of the laser beam may be achieved by any means that would be known to the skilled person. For example, the method may be performed by having the focal point of the laser beam fixed in space, and the glass mounted on a support that moves relative to the focal point of the laser beam. Alternatively, the method may be performed by having the glass mounted on a support that is fixed in space, and the focal point of the laser beam moved relative to the glass. As a skilled person would know, the setup may be automated for the precise inscription of optical waveguides of predetermined shape within the glass.

The focal point of the laser beam may be moved relative to the glass at any speed conducive to formation of optical waveguides of the kind described herein within the glass. In that regard, the specific composition of the aluminosilicate glass of the present invention ensures that optical waveguides can be laser inscribed within the glass across a wide range of writing speeds. By “writing speed” is meant here in the speed at which the focal point of the laser beam moves relative to the glass.

In some embodiments, the focal point of the laser beam is moved within the glass at a speed of at least 5 mm/minute. For example, the focal point of the laser beam may be moved within the glass at a speed of at least about 10 mm/minute, at least about 20 mm/minute, at least about 50 mm/minute, at least about 100 mm/minute, at least about 200 mm/minute, at least about 500 mm/minute, at least about 1000 mm/minute, at least about 2000 mm/minute, at least about 3000 mm/minute, at least about 4000 mm/minute. In some embodiments, the focal point of the laser beam is moved within the glass at a speed of at least 500 mm/minute. In some embodiments, the focal point of the laser beam is moved within the glass at a speed of up to 4000 mm/minute. For example, the focal point of the laser beam may be moved through the glass at a speed of from 10 mm/minute to 4000 mm/minute.

As it would be clear to the skilled person, the desired writing speed may be achieved by having the glass fixed in space and moving the focal point of the laser beam relative to the glass, by having the focal point of the laser beam fixed in space and moving the glass relative to the focal point of the beam, or by a combined movement of the focal point of the beam and the glass relative to one another.

As the focal point of the laser beam moves through the glass, the volume glass corresponding to the focal point of the laser beam undergoes a quick cycle of heating followed by cooling (quenching) as the focal point of the laser beam moves away. During said cycle, the composition of the glass changes locally, for example according to a mechanism postulated herein. As discussed herein, the local rearrangement of the glass composition is associated with a local and permanent change of the glass refractive index along the path of the focal point of the laser beam.

Accordingly, the method of the invention may also be characterised by a specific quenching time. By the expression “quenching time” is meant the time it takes for the glass to cool from the peak temperature induced by the laser focal point to a temperature that does not result in any further modification of the refractive index. The value of said when the time results from the specific parameters of the laser beam (e.g. wavelength, power, repetition rate, etc.) and the composition of the glass. Typically, the method of the invention would be characterised by a quenching time as low as 0.1 ms. In some embodiments, the quenching time is between 0.45 ms to 90 ms. For example, the quenching time may be 0.45 ms, 0.9 ms, 1.8 ms, 4.5 ms, 9 ms, 18 ms, 45 ms, or 90 ms. The skilled person would be able to perform the method to achieve the quenching times described herein by, for example, selecting an appropriate quench rate, which in turn is a function of waveguide size for a given feed rate value.

As it will be understood, the quenching time increases as the writing speed decreases since the glass cools from progressively higher temperatures. In some embodiments, the quenching time is 0.45 ms, 0.9 ms, 1.8 ms, 4.5 ms, 9 ms, 18 ms, 45 ms, or 90 ms in correspondence to a writing speed of 2000 mm/minutes, 1000 mm/minutes, 500 mm/minutes, 200 mm/minute, 100 mm/minute, 50 mm/minute, 20 mm/minute, or 10 mm/minute, respectively.

Moving the focal point of the laser beam through the glass under the conditions described herein results in formation of an optical waveguide. Without wanting to be limited by theory, moving the focal point of the laser beam through the glass can induce smooth isotropic changes of the glass composition along the path of the focal point, thus provoking Type I modifications of the glass refractive index. The specific composition of the aluminosilicate glass of the invention ensures that main glass forming elements are matched with their field strength by a glass former or an intermediate, ensuring high probability of obtaining waveguides with a positive refractive index contrast. Typically, the glass forming the core of the waveguide will have a refractive index higher than that of the surrounding glass.

The specific composition of the aluminosilicate glass of the invention ensures that upon exposure to the focal point of the laser beam the glass rearranges its composition resulting in higher refractive index across a wide range of writing speeds. Without wanting to be limited by theory, it is believed that the change of refractive index at different writing speeds is driven by different mechanisms depending on the specific writing speed. For instance, it is postulated that at low writing speeds (i.e. below 200 mm/minute) the index change is a result of strong cross-migration of alkaline earth elements (e.g. Ca), Al and Si. On the one hand, alkaline earth elements such as calcium migrate preferentially into the waveguide core and silicon, which contributes to lower the refractive index, accumulates at the interface between the core and the surrounding glass.

In contrast, at high writing speeds (i.e. above 500 mm/minute) the index change is dominated by the migration of the alkaline earth elements (e.g. Ca). Accordingly, it is believed that the source of higher refractive index at faster feed rates (i.e. writing speed) stems from the migration of relatively heavy alkaline earth elements. The role of alkaline earth elements (e.g. Ca) in positive refractive index change in fast writing speeds was attributed to the high diffusivity of those elements at higher melt viscosities relative to Al and Si.

The waveguide formed by the method of the invention may have any shape and dimension conducive to preferential transmission of light over the surrounding glass. Accordingly, the optical waveguide obtained by the method of the invention may be in the form of a nonplanar waveguide or a planar waveguide.

In some embodiments, the optical waveguide is a nonplanar waveguide. In those instances, the waveguide provides two-dimensional transverse optical confinement. For example, the waveguide may be in the form of a channel waveguide. In those instances, the waveguide would consist of a longitudinally extended high-index core transversely surrounded by low-index glass, resulting in a closed-section channel guide having a main longitudinal direction along which photons propagate preferentially relative to the surrounding glass. Such optical waveguide may be obtained by moving the focal point of the laser beam along a linear path within the glass. As a skilled person will understand, the cross-sectional shape of a nonplanar waveguide will be dictated by the shape of the focal point of the laser beam.

In some embodiments, the optical waveguide is a planar waveguide. By the waveguide being “planar”, the waveguide provides optical confinement in only one transverse direction. Such optical waveguide may be obtained by moving the focal point of the laser beam such that it scans a planar section of the glass.

The method of the invention advantageously affords formation of optical waveguides having significantly lower optical losses relative to waveguides or obtained using conventional glasses. For example, optical waveguides obtained with the method of the invention provide an optical loss of less than 0.2 dB/cm within a wavelength range of 500 to 3000 nm. In some embodiments, the optical waveguide provides an optical loss of less than 0.3 dB/cm, less than 0.5 dB/cm, less than 0.75 dB/cm, or less than 1 dB/cm. For example, the optical waveguide provides an optical loss between 0.1 dB/cm and 0.3 dB/cm.

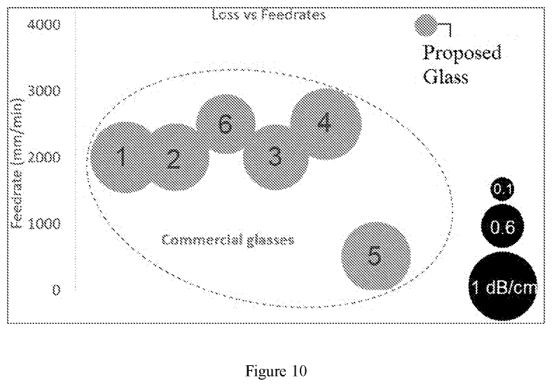

Advantageously, the method of the invention affords the production of low-loss optical waveguides at high throughput. For example, the method of the invention allows formation of optical waveguides that consistently provide a loss of less than 0.2 dB/cm at a writing speed of up to 4,000 mm/minute. For comparison, writing speeds above 1,500 millimetres/minute in commercial glass already result in the formation of optical waveguides providing significant losses (i.e. about 1 dB/cm). In addition, the glass of the invention ensures structural consistency for optical device integration over a broad processing window, whereas commercial glasses may be operated only within a very narrow processing window. A comparative diagram in that regard is shown in FIG. 10.

The aluminosilicate glass and the method of the invention can provide a significant contribution in the field of optics, including large scale and high throughput production of optical components and photonic waveguide circuits for optical communication, sensing, and life science.

The specific composition of the glass of the invention makes it also suitable for the high throughput production of display glasses. In that regard, the aluminosilicate glass of the invention is characterised by a particularly high resistance to chemicals, which would make it suitable to withstand chemically aggressive washing cycles necessary to minimise production times.

### EXAMPLES

### Example 1

Synthesis of Glass

Sample glass of formula (I) have been produced by melt quenching. Raw materials comprising the chemicals described in the formula was prepared in a batch, each weighing in accordance to the percentage weight formula. The mixture was subsequently ball milled for an hour then transferred into a platinum crucible and placed in a high temperature furnace. The furnace was fired to a temperature of about 1,650° C. and the mixture left to melt for at least 6 hours.

The melt was subsequently quenched to room temperature to form a glass. Glass samples were annealed at a temperature around 750° C. for 18 hours. Samples having compositions detailed in Table 1 were produced. The table also reports, for comparison, compositions of commercially available glasses.

TABLE 1
Compositional parameters of glass samples
representative of the invention, and of
commercial glasses for comparison

| Sample | x | a₁ | b₁ | a₁ × b₁ |
|---|---|---|---|---|
| Glass-1 | 18.00 | 0.556 | 0.833 | 0.463 |
| Glass-2 | 18.00 | 0.572 | 0.65 | 0.372 |
| Glass-3 | 18.00 | 0.676 | 0.706 | 0.478 |
| Glass-4 | 20.00 | 0.550 | 0.65 | 0.358 |
| Glass-5 | 15.3 | 0.654 | 0.654 | 0.427 |
| Glass-6 | 17 | 0.588 | 0.647 | 0.381 |
| Glass-7 | 18 | 0.611 | 0.722 | 0.441 |
| Glass-8 | 18 | 0.555 | 0.647 | 0.359 |
| Glass-9 | 16 | 0.633 | 0.733 | 0.464 |
| Glass-10 | 18 | 0.638 | 0.666 | 0.425 |
| Glass-11 | 19 | 0.605 | 0.673 | 0.407 |
| Commercial-1 | 15.83 | 0.512 | 0.0013 | 0.001 |
| Commercial-2 | 17.11 | 0.510 | 0.0012 | 0.001 |
| Commercial-3 | 17.39 | 0.420 | 0.0057 | 0.002 |
| Commercial-4 | 20.29 | 0.083 | 0.767 | 0.063 |
| Commercial-5 | 12.93 | 0.000 | 1.585 | 0.000 |
| Commercial-6 | 11.6 | 2.0698 | 0.031 | 0.064 |

### Example 2

Direct Laser Writing of Optical Waveguides

Femtosecond laser has been used for writing optical waveguides using a number of test glasses obtained according to the procedure described in Example 1. The waveguides were produced by modifying the refractive index in the laser-irradiated areas, leading to direct inscription of Type I waveguides by inducing positive refractive changes to form the waveguide cores. The waveguides are written with various laser parameters and focal conditions to have different propagation modes and/or mode field sizes due to the versatile requirements from the applications.

Optical waveguides were inscribed using a pulse femtosecond oscillator (Femtosource XL500, Femtolasers GmbH) emitting 50 fs pulses and operating at a wavelength of 800 nm. Circularly polarized pulses were focused inside the glass using an Olympus UPLAN SAPO 100× oil immersion microscope objective (NA≈1.4). Oil was used to reduce the refractive index mismatch, thus mitigating spherical aberration. Waveguides were written using a set of 3-axis computer controlled high precision Aerotech air-bearing linear stages at a depth of 170 um.

The glass samples were attached to a substrate, which was made to move relative to the microscope objective by means of a X-Y-Z controlled stage. For the most basic tests, the stage was moved along one direction only at increasing feed rates to inscribe straight linear waveguides. The glass was moved relative to the lens at feed rates of 10, 20, 50, 100, 200, 500, 1000 and 2000 mm/min. At each feed rate, the pulse energy was adjusted to result in a μm wide structure. This means that, for each feed rate, the temperature at a distance of 15 μm away from the focal spot was insufficient to induce any refractive index modification. As defined herein, the quenching time was taken to be the time it takes for the glass to cool from the peak temperature at the focal spot to a temperature that does not result in any further refractive index modification. In the case of this Example, this corresponded to the time it took for the sample to move by 15 μm. Hence, the resulting quenching times were 90, 45, 18, 9, 4.5, 1.8, 0.9 and 0.45 ms at a feed rate of 10, 20, 50, 100, 200, 500, 1000 and 2000 mm/min, respectively.

All waveguides had a highly circular cross-section, indicating good spherical aberration compensation. Above 100 mm/min feed rate, the guiding region was highly circular which is generally a highly desirable feature in photonic device fabrication due to reduction in propagation losses avoiding hard angles that might help the propagating light to reach beyond the critical angle at those interfaces.

The waveguide morphology can be described as a core-shell structure. At feedrates greater than 100 mm/min, the core comprises of a bright positive index change region with a concentric dark negative index change region. For feed rates slower than 100 mm/min the appearance of the core is inverted with a central dark zone with concentric bright ring. The shell is the heat-affected zone, which appears as a halo around the central core.

### Example 3

Waveguide Characterisation

Refractive index measurements on waveguides obtained according to a procedure described in Example 2 were carried out using a SID4 HR camera from Phasics based on the quadriwave lateral shearing interferometric technique (QWLSI). The camera spatially resolves optical path length differences resulting from the laser induced refractive index modification. For this purpose, the samples were thin-sectioned to thicknesses less than 100 μm and the thickness determined with ˜1 μm accuracy by confocal measurement of the distance between the optical reflection from the front and back surface, respectively. The thickness was used to convert optical path length difference to refractive index change. All measurements were carried out using a quasi-monochromatic light source at 600 nm with 25 nm FWHM bandwidth under 64× magnification. This resulted in a spatial resolution of ˜0.5 μm.

SEM imaging and X-ray intensity mapping of constituent elements were carried out on a JEOL JXA-8500F field-emission EPMA. Formation of waveguides in all samples was observed to due to selective migration of elements. Accumulated Si formed regions of lower index, while accumulation of Ca and Al within the waveguide core contributed to a positive index zone.

Raman spectroscopy was carried out on a Renishaw inVia Raman Microscope with 514 nm laser excitation using a 100× objective operated in confocal mode to achieve the highest spatial resolution possible (0.5 μm).

Relevant spectrum regions were 300-700 cm⁻¹, 700-1250 cm⁻¹ and 1250-1550 cm⁻¹. The strong peak at 478 cm⁻¹ and shoulder at 590 cm⁻¹ correspond to the well-known defect bands D1 and D2 of the siloxane rings. Presence of alkaline earth metal can produce a cation band vibration near 350 cm⁻¹, unless the alkaline earth metal concentration is well below 20 wt %. The broad peak present at 353 cm⁻¹ is attributed to the Si—O—Si bond rocking and bending vibrations in SiO₄ tetrahedra. The 674 cm⁻¹ peak correspond to the vibrations from the ring structured metaborate groups.

The second region at 700-1250 cm⁻¹ is found to be very sensitive to the addition of aluminium, which act as a perturbing source on those bands. The spectral band at 790 cm⁻¹ is attributed to two different sources in the literature, one is that it is a manifestation of Al—O stretching and the second hypothesis is that the band is predominantly Si—O in nature with aluminium acting as a perturbation. Following this band there are three convoluted vibrational peaks at 932, 1042 and 1155 cm⁻¹ that might commonly be attributed to the well-known Q2 (two non-bridging oxygen atoms per silicon), Q3 (three non-bridging oxygen atoms per silicon) and Q4 (fully polymerized SiO₄) Si—O— stretching vibrations. However, due to the presence of aluminium these are revised/analogous peaks corresponding to symmetric stretching vibrations of silicate tetrahedral with four, three and two oxygens bound to aluminium respectively. The bands between 1250 and 1550 cm⁻¹ can be assigned to borate groups.

The bandwidth of 353 cm⁻¹ peak shows a well-defined variational behaviour for all feed rates. The bandwidth increases for the positive index change zone irrespective of federate. The variation of bandwidth as a function of federate is observed to follow the trend of calcium migration.

Shifting of the SiO₄ tetrahedral bending and rocking vibrational peak to lower wavenumber generally indicates either a less strained glass matrix or an increase in long-range order (onset of crystallization).

The four membered siloxane ring vibration at 478 cm⁻¹ shows a monotonic increase in vibrational frequency at all zones indicating Si—O bond shortening. Since the magnitude of frequency shift is 2-3 times higher in the positive refractive index change region compared to the negative index change region with respect to the bulk glass, it explains the influence of calcium atom migration. Additionally, it could be deduced that migrated aluminium fails to depolymerize the long-range network and hence it may preferably assume the role of glass former rather than a modifier.

The three membered siloxane ring vibration (D2) at 590 cm⁻¹ follows a peak shift congruent to the migration of calcium rather than silicon or aluminium. In this case, it should follow calcium migration as it was the major variable affecting refractive index.

The variation of the positive index change region follows the aluminium migration where it shift from −3.1 cm⁻¹ (higher Al content) to −2.5 cm⁻¹ (low Al content) relative to the bulk as the feed rate is increased. The 932 cm⁻¹ peak is considered to be the modified Q2 due to the presence of aluminium. Therefore, these data further suggest that the role of migrated aluminium is confirmed as a glass former rather than a modifier because the 3+ charge on aluminium should produce strong modification to the Q3 upon migration. Migration of calcium is evident as it is the strongest perturbation influence on Q2 due to its 2+ charge. The vibration is seen shifting to higher frequency where the calcium content increases. A bandwidth increase suggests the increase in short range order due to depolymerization and finally the intensity of the peak is seen increasing at the calcium rich zone irrespective of feed rates.

The final proof of aluminium assuming the role of glass former came from the result of the increase in intensity of Q4, which is a direct result of the increase in fully polymerized SiO₄ units and that too in an aluminium rich zone. The role of incoming aluminium as a modifier not only would have hindered this, it would have depolymerized the existing Q4 in the matrix. Hence, the mixed modifier effect cannot be used to explain the nonlinear behaviour of refractive index with different feed rates nor does it account for the calcium migration observed.

Though calcium has a comparatively larger ionic radius, it has a lower cationic charge (2+) in comparison to Al (3+) and Si (4+). Since doubling the charge results in an effectively higher drop in diffusivity than doubling the ionic radius, the discrepancy in diffusivity could be used to explain the preferential calcium migration. It is well known that solidification of glass happens with a higher glass transition temperature when the quenching rate is higher. So one could infer that solidification happens at a higher viscosity for faster feed rate (fast quench) compared to a slow feed rate (slow quench).

The data allows to postulate that the selective migration of calcium at faster feed rates stems from the fact that solidification happens at high viscosity where calcium is several orders more mobile than silicon or aluminium. For very slow feed rates, the discrepancy of diffusivity between silicon, aluminium and calcium is much lower since the melt translates along a low viscosity regime before solidification happens.

### Example 4

Effect of Alkaline Earth Metal Oxide to Al₂O₃ Ratio

It was found that stronger confinement of light within the waveguide core will help to reduce optical losses. As such, a beneficial ratio of CaO to Al₂O₃ was found by custom designing glasses with varying ratios from 0.35 and above. For the purpose of this example, the CaO to Al₂O₃ ratio of glass samples obtained according to a procedure described in Example 1 was varied from 0.35 to 0.77. The basic composition of the glass was (52-62)SiO₂·(15-20)Al₂O₃·(7-14)CaO·(5-10)B₂O₃. The relative amount of the glass components was varied at the cost of SiO₂ content.

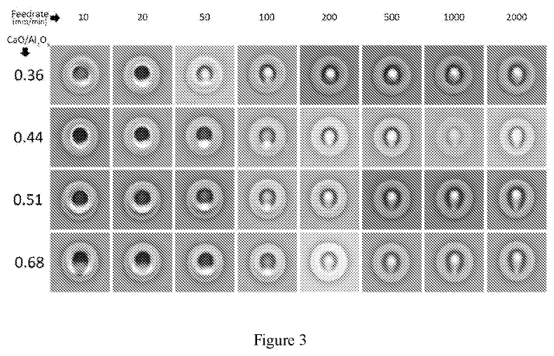

Glasses with ratios of 0.36, 0.44, 0.51 and 0.68 were selected to fabricate waveguides using conditions described in Example 2. FIG. 3 shows images of the cross-section of the resulting waveguides. The studies were based on fabricating 30 μm waveguide structures at different feed rates and following results were obtained.

Overall, it was observed that the glass with higher aluminium content (a₁=0.36) tends to maintain a better aspect ratio to the guiding region over a large feed rate window. It was also found that increasing the calcium (a₁=0.68) start to show phase separation, especially at low feed rates, and that a good ratio to avoid phase separation was for glasses with a₁ lower than 0.65, unless a second modifier is added that will help to raise the ratio.

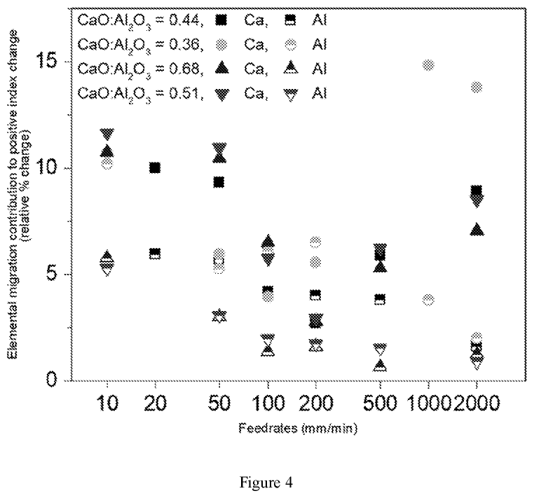

The magnitude of individual elemental migration towards the positive refractive index zone of some selected waveguides in the custom glasses listed in Table 1 is shown in FIG. 4, in which the value of a₁ for sample “Custom-1” is 0.44, “Custom-2” is 0.36, “Custom-3” is 0.68, and “Custom-4” is 0.51.

The Refractive index change relates to 30 μm structure waveguides written at 10-2,000 mm/min feed rates for different CaO to Al₂O₃ ratio. The data reveals that glass with ratio of 0.51 gave the higher refractive index change in comparison to the other three glasses across the widest feed rate window. From Example 3 it was observed that glass with higher calcium content gave higher refractive index. The fact that in this Example a₁=0.68 failed to provide a better performance underlines the importance of waveguide morphology and chemistry post inscription. Even though 0.36 and 0.44 performed poorly at slower feed rates in comparison to 0.51, all three of them gave similar values at high feed rates. This substantiates the role of viscosity for calcium migration as viscosity increases with silica content. Calcium has a higher diffusivity value at higher viscosities and since the content of silica was almost 7-10 wt % higher in 0.36 and 0.44, it was reflected at higher feed rates. While the elemental migration data do validate this observation, it is mutually linked to the networking of the glass post inscription and migration.

### Example 5

Effect of Alkali Metal Oxide to Al₂O₃ Ratio

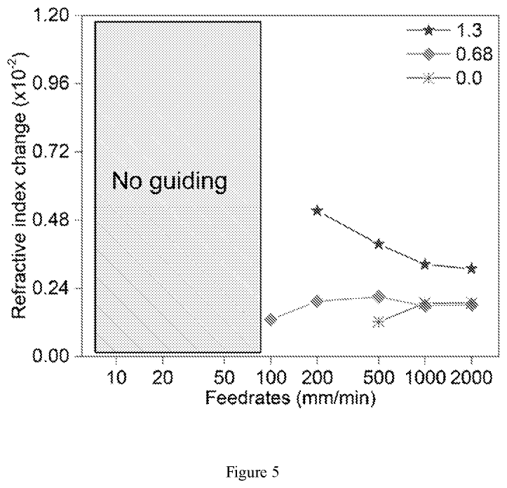

In this Example, glass samples obtained according to a procedure described in Example 1 were made. Three glasses were produced, having a b₁ value of 1.3, 0.63 and, for comparison, 0.0 (i.e. glass with no Al₂O₃ content instead replaced with CaO and adjusted the rest with higher SiO₂ content). Accordingly, the basic compositions were around (62-72)SiO₂·(0-20)Al₂O₃·(0-8)CaO·(15-20)Na₂O. Waveguides were fabricated using conditions described in Example 2. The total refractive index profile of the waveguides shown in FIG. 5, relative to 30 μm structures, provides a number of indications.

For example, the data indicates that presence of aluminium and alkaline earth metal is needed to ensure a guiding region within the core of the waveguide over a large parameter window. Also, it was observed that waveguides written at low feed rates in the glass without aluminium (CaO/Na₂O=0.56) exhibited phase separation quite similar to the 0.68 CaO/Al₂O₃ ratio glass described in Example 4. This indicates Na₂O can be used to avoid phase separation to a ratio quite similar to that with Al₂O₃.

Also, it was observed that addition of sodium can lower the melting point of the glass effectively easing up the glass fabrication process, and that glass with b₁ ratios of 1.3 produced waveguides with higher positive index core compared to those with b₁ of 0.63 or 0.0.

### Example 6

Effect of Varying Alkaline Earth Type

Glass samples obtained according to a procedure described in Example 1 were made. The basic compositions of the glasses were around (55-65)SiO₂·(10-20)Al₂O₃·(4-15)CaO or BaO·(10-20) Na₂O. Details of the specific compositions of the sample glasses are listed in Table 1 (Glasses 8-11). Glasses 8-9 contain calcium, and glasses 10-11 contain barium.

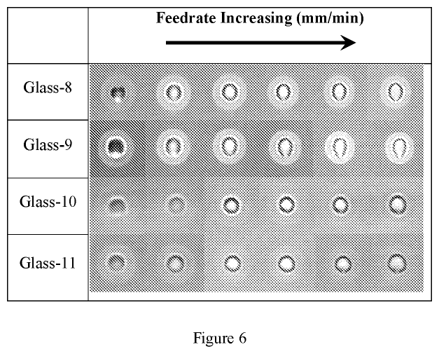

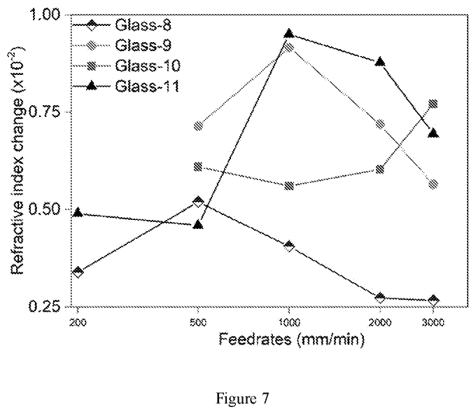

The effect of refractive index and the feed rate tunability by varying the a₁ and b₁ even by changing the type of alkaline earth oxide metal can be directly observed in the plot of from FIG. 7. Higher a₁ and b₁ values for glasses 9-11 demonstrate higher refractive index change for faster feedrates. Glass 10 (with barium) was observed to perform particularly well at feedrates higher than 1000 mm/min and shows an increasing trend beyond 3000 mm/min. Glass 9 though containing Ca can perform as well as those containing Ba. However, presence of Ba in the glass advantageously provide for significantly higher circular morphology of the core relative to commercial glasses (see FIG. 6). Circular morphology of the guiding region ensures low scattering loss and ideal coupling to optical fibers.

### Example 7

Comparison with Commercial Glass

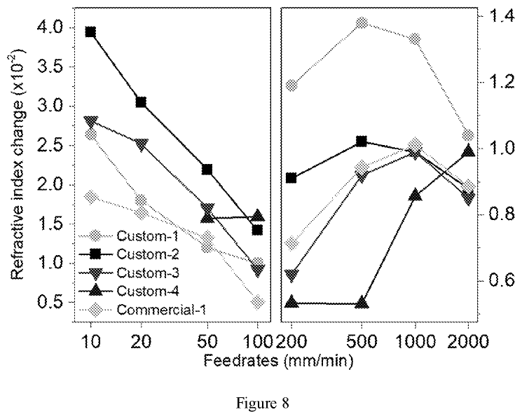

The refractive index change of waveguides obtained in customised glass by the procedure described in Example 2 was compared to that of waveguides obtained using commercial glass. The comparative data is shown in FIGS. 8-10.

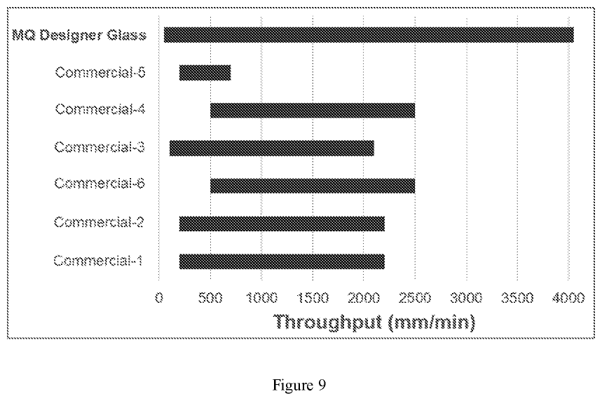

The data of FIG. 8 confirms that glass according to the present invention can outperform commercial glass for making optical waveguides across all feed rate tested. The data of FIG. 9 emphasises the possibility to use glass according to this invention for the direct laser writing of optical waveguides across a much wider range of writing speeds relative to a number of commercial glasses. FIG. 10 confirms that the resulting waveguides are also characterised by significant lower optical losses relative to those obtained using commercial glass.

Every formulation or combination of components described or exemplified can be used to practice the invention, unless otherwise stated. Specific names of compounds are intended to be exemplary, as it is known that one of ordinary skill in the art can name the same compounds differently.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. An aluminosilicate glass having a composition according to the following formula (I):
(100−(1+a₁+b₁)·x)SIO₂·(x)Al₂O₃·(a₁·x)MO·(b₁·x)R (wt %) (I)
in which,
MO is alkaline earth metal oxide, the alkaline earth metal M being one or more of Mg, Ca, Sr, and Ba,
R comprises alkali metal oxide, the alkali metal being one or more of Li, Na, and K,
x is at least 15,
a₁ is at least 0.35, and
b₁ is at least 0.55,
wherein the product of a₁ and b₁ is at least 0.22.

2. The aluminosilicate glass according to claim 1, wherein R further comprises B₂O₃.

3. The aluminosilicate glass according to claim 2, wherein B₂O₃ is present in an amount of less than 10 wt % B₂O₃.

4. The aluminosilicate glass according to claim 1, wherein x is from 15 to 25.

5. The aluminosilicate glass according to claim 4, wherein x is 18.

6. The aluminosilicate glass according to claim 1, wherein a₁ is from 0.45 to 0.75.

7. The aluminosilicate glass according to claim 6, wherein a₁ is 0.5.

8. The aluminosilicate glass according to claim 1, wherein b₁ is from 0.55 to 0.8.

9. The aluminosilicate glass according to claim 1, wherein b₁ is 0.835.

10. The aluminosilicate glass according to claim 1, comprising from 50 wt % to 70 wt % of SiO₂.

11. The aluminosilicate glass according to claim 1, having a refractive index in a range of from 1.45 to 1.55.

12. The aluminosilicate glass according to, further comprising iron in an amount leading to a Fe²⁺ absorption of less than 0.2 dB/cm at 1,100 nm.

13. The aluminosilicate glass according to, wherein MO comprises CaO.

14. The aluminosilicate glass according to claim 1, having an optical waveguide inscribed therein.

15. A method of forming an optical waveguide, the method comprising the steps of:
focusing a laser beam within an aluminosilicate glass according to claim 1,
moving a focal point of the laser beam through the glass, thereby forming the optical waveguide.

16. The method according to claim 15, wherein the focal point of the laser beam is moved through the glass at a speed of at least 10 mm/min.

17. The method according to claim 15, wherein the focal point of the laser beam is moved through the glass at a speed of from 10 mm/min to 4,000 mm/min.

18. The method according to claim 15, wherein the laser beam is an ultrashort laser beam with a duration shorter than 10 picosecond and operating at a wavelength in the range of from about 400 to about 2,200 nm.

19. The method according to claim 15, wherein the laser beam is an ultrashort laser beam with a duration shorter than 10 picosecond and operating at a repetition rate in the range of from 10 kHz to 100 MHz.
